(19) United States
(12) Patent Application Publication
(10) Pub. No.: US 2011/0208615 A1
(43) Pub. Date: Aug. 25, 2011

(54) System and Method For Creating and Marketing Authentic Virtual Memorabilia

(76) Inventors: Ryan Steelberg, Irvine, CA (US); Chad Steelberg, Newport Beach, CA (US)

(21) Appl. No.: 12/712,637

(22) Filed: Feb. 25, 2010

(51) Int. Cl. G06Q 30/00

(52) U.S. Cl. 705/27.1; 705/26.3

(57) ABSTRACT

A system and method for creating and marketing authentic virtual memorabilia is disclosed. The System and method include at least one computer server, at least one database connected to said at least one computer server, a communication connection for connecting said at least one computer server to a network, software hosted on said at least one computer server, said software configured to create a marketplace for limited edition authentic virtual memorabilia, said software further configured to provide an auction environment for said authentic virtual memorabilia, said software further configured to allow display of said limited edition authentic virtual memorabilia in a showcase.

### CROSS REFERENCE TO RELATED APPLICATIONS

The present application claims priority to U.S. Provisional Application No. 61/024,306 entitled “System and Method for Creating and Marketing Authentic Virtual Memorabilia,” filed Jan. 29, 2008, the entire disclosure of which is incorporated by reference herein as if set forth in its entirety.

### BACKGROUND OF THE INVENTION

1. Field of the Invention

Embodiments of the invention described herein pertain to the field of computer systems. More particularly, but not by way of limitation, one or more embodiments of the invention enable a system and method for creating and marketing authentic virtual memorabilia.

2. Description of the Related Art

The Internet today contains several examples of virtual products, the purchase and sale of which creates a virtual economy where legal tender (“real world money”) is exchanged for virtual currency. Prior systems exist for the creation and marketing of these virtual products, including popular social networking systems such as Facebook and various role-playing virtual worlds such as Second Life.

Generally in the virtual worlds, real world money is exchanged for “virtual money” at some established exchange rate. As an example, Second Life users purchase and trade “Lindens” as currency. Created by Linden Labs, users of the popular website create avatars associated with a unique login and password. The user then pays Linden Labs with real world money to purchase a number of Lindens, based on the current exchange rate. Lindens can be used to purchase virtual clothing, accessories, services and land in the virtual world. Lindens may also be cashed out for real world money. As a further example, the popular social networking website, Facebook, offers digital images of “gifts” that a user can purchase and then send to another user as a “gift.” These virtual gifts can be acquired for free or for a token charge; many on Facebook today cost as little as one dollar. Some Facebook gifts are sold in limited editions.

FIG. 1 illustrates an example of the prior art system of Facebook for purchasing Facebook gifts. When a user purchases a Facebook gift, a digital image of the gift is sent electronically to the recipient. The recipient may display the image on their Facebook profile page or other Facebook pages associated with the recipient.

Another illustration of a marketplace for creating and selling virtual products and services is in Second Life. Numerous major corporations have signed on to sell virtual versions of their products including American Apparel and Adidas, which both sell virtual versions of their clothing for use on avatars on Second Life. These virtual clothing “stores” sell virtual products to users for Lindens, which can then be converted to real world money. A Second Life user can collect an entire wardrobe of virtual clothing and jewelry for their avatar, spending real world money in a virtual world.

Online marketplaces exist for the trading of real world memorabilia as well. The “etopps” area on eBay permits users to trade real world sports cards. However, none of these prior art systems allows for authentication of limited edition digital virtual memorabilia. Prior art systems lack the ability to manage authentic autographs combined with limited edition digital virtual memorabilia. Prior art systems also fail to provide a secure marketplace for sale and trading of authentic limited edition digital virtual memorabilia.

For at least the limitations described above there is a need for a system and method for creating and marketing authentic virtual memorabilia.

### BRIEF SUMMARY OF THE INVENTION

A system and method for creating and marketing authentic virtual memorabilia is disclosed. The System and method include at least one computer server, at least one database connected to said at least one computer server, a communication connection for connecting said at least one computer server to a network, software hosted on said at least one computer server, said software configured to create a marketplace for limited edition authentic virtual memorabilia, said software further configured to provide an auction environment for said authentic virtual memorabilia, said software further configured to allow display of said limited edition authentic virtual memorabilia in a showcase.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an example of a virtual product sold for real money—Facebook Gifts.

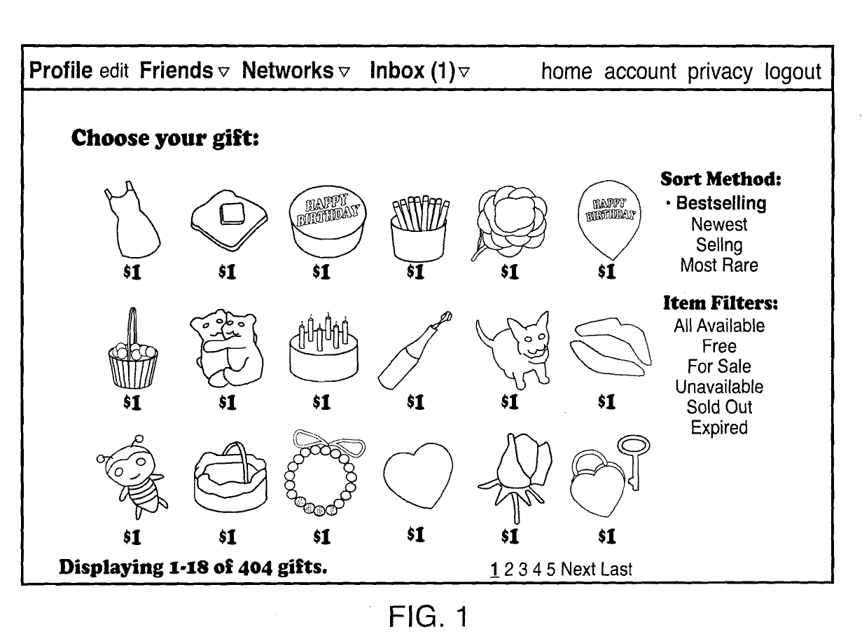

FIG. 2 illustrates an example of virtual memorabilia, in this example a Joe Montana autographed football. This piece of authenticated digital memorabilia would consist of a digital image of a football combined with a digital autograph of Joe Montana.

FIG. 3 illustrates an example of a virtual memorabilia user's showcase, where their different virtual memorabilia items are on display on a social network website, in this example, Facebook.

FIG. 4 illustrates an exemplary architecture for a system of the present invention.

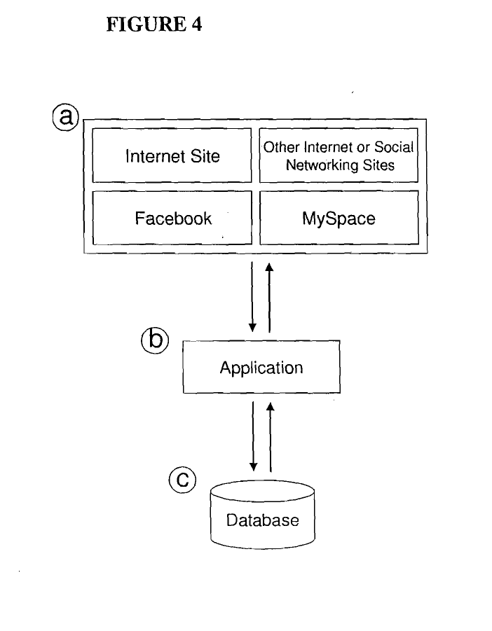

### DETAILED DESCRIPTION

A system and method for creating and marketing authentic virtual memorabilia will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

The present invention describes a process and method for creating and marketing authentic virtual memorabilia. Authentic virtual memorabilia, as used herein, comprises a data object or other digital data record, kept in one or more computers, of a digital image, method of authentication, and optionally a digital autograph. A digital image, as used herein, may refer to a data representation or animation of any physical object. A method of authentication, as used herein, comprises any means for verifying the authenticity, source, and uniqueness of the data object as an original or authorized object, as known to those of skill in the art of cryptography. The digital image, as part of an authentic virtual memorabilia data record, may be associated with the digital image of an autograph (a “digital autograph”) of a famous person, personality, character, virtual person (“avatar”) or other “individual” that increases the value of the authentic virtual memorabilia, as would a real world autograph with real world memorabilia. Digital autographs, as used herein, are intended to represent an authorized autograph used with the permission of the individual to whom that autograph belongs.

### Digital Images

The system of the present invention may utilize one or more technologies well known to those of ordinary skill in the art to create and represent digital images of memorabilia. Any format of image known to web browser software may be used. Images may be captured using a digital camera, video camera, cell phone, scanner, or other method of creating a digital image of a real world object. Further, the system and method herein is not limited to real world objects, but may be used to market images other limited edition virtual objects, such as art, animations, authentic logos, photographs, or other similar items or objects whose value is associated with their limited nature and verified authenticity. The system and method of the present invention may support images captured digitally, as described herein, as well as images created using graphic applications such as Photoshop, Acrobat, Flash, Amara, KoolMoves, GIF animation programs, or any other type of graphic design, editing or creation software. For example, tickets to a virtual concert, or virtual stock might be bought and sold in a marketplace based on the system of the present invention.

### Authentication

Authenticating an image of a digitally imaged autograph is very different than other digital signature authentication techniques. In other digital signature technologies, a combination of a public and private key is used to authenticate a digital document, such as an email or a contract. In digital signature technologies, no physical or image of an actual signature or autograph is used. The present invention may authenticate a created digital image of an autograph or signature using one or more of the methods of authentication discussed in further detail below.

### Digital Autograph

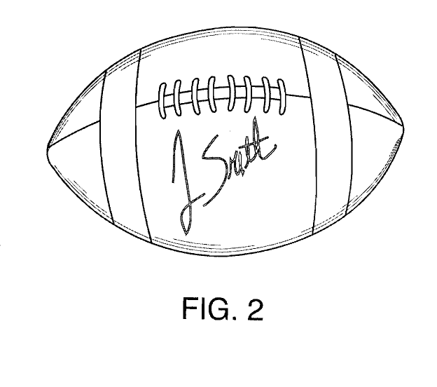

To enhance the value of memorabilia created and traded in the present invention, in a preferred embodiment digital memorabilia will be combined with a digital autograph image, where rights to digital autograph may be granted by the signatory, or in the case of a deceased person, character or virtual person, by the authorized representative thereof. FIG. 2 illustrates an example of a digital memorabilia item combined with a digital autograph. In this case, the illustration is of an autographed virtual football autographed by NFL quarterback Joe Montana. In the system of the present invention, a preferred embodiment would require that Joe Montana authorized the use of the digital image of his autograph on that specific virtual memorabilia item.

### Ownership Information

Along with storing authentication data for each piece of virtual memorabilia, the present invention may also store other relevant information for each piece of virtual memorabilia in a central database. This information may include, but is not limited to, owner's name, autographer's name, edition number, authentication information, transaction history, digital image data, autograph image data, digital rights management information, and any other information required to identify, display and authenticate the virtual memorabilia. The central database of the present invention may also store ownership information related to past and present auctions of the piece of virtual memorabilia, such as purchase price history, bid history, and other historical information regarding ownership of the piece. This information may be stored with the ownership information, or may be hosted separately on another server. The ownership information for a piece of virtual memorabilia in the system of the present invention may also include item tracking information. Item tracking information may comprise item identification and chain-of-title information for each piece of virtual memorabilia. The purpose of item tracking information is to assist the system of the present invention in guaranteeing ownership of the item, and thereby to help prevent fraud, and create a secure marketplace where limited edition virtual memorabilia items may be traded, sold, or gifted with confidence.

### Digital Marketplace

The system and method of the present invention contemplates the creation of a secondary marketplace for authenticated virtual memorabilia products. In one or more embodiments, any virtual memorabilia purchased through the online application of the present invention may be resold, traded, or gifted through an online marketplace. The invention contemplates a user interface where any already purchased item may be listed for sale or auction. Auctions may be held online or otherwise, using the software of the present invention or other systems for online auctions as desired. If authentic virtual memorabilia of one or more embodiments of the invention are resold, traded, or gifted, the system may record the transfer of ownership information in a central database. This record of transfer is preferably associated with authentication information for that item. Once this transfer happens, the transferred item may be displayed in the new owner's showcase.

### Memorabilia Showcase

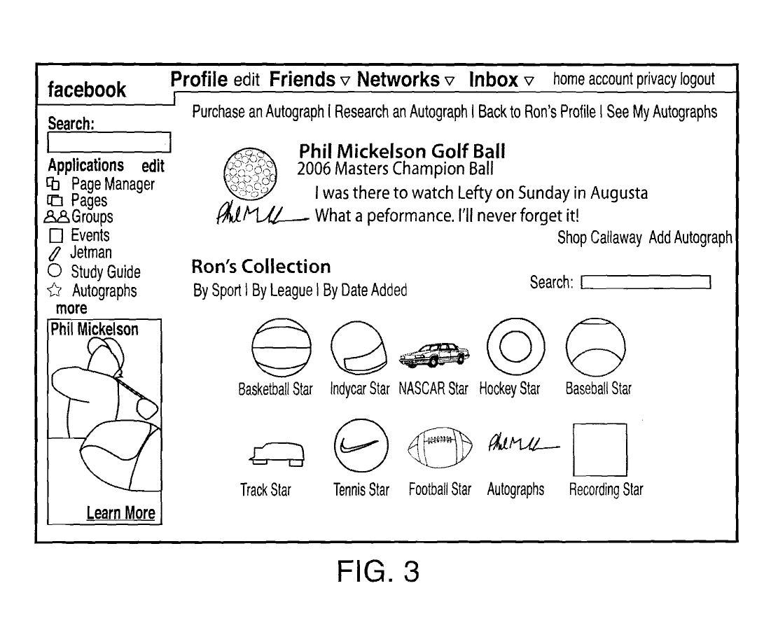

FIG. 3 illustrates an exemplary version of a virtual memorabilia showcase in one or more embodiments of the present invention. All virtual memorabilia purchased in the present invention may be displayed in a virtual showcase. The virtual showcase may be hosted by the provider of the present invention, or may be integrated into the system of one or more other virtual world providers. For example, FIG. 3 illustrates authentic virtual memorabilia displayed in a showcase integrated into Facebook. In a preferred embodiment, the showcase function of the present invention may be provided to virtual world or social networking site as an application interface configured to operate with the provider's website, but hosted from a central server. In an alternate embodiment the showcase function may be provided as an application that may be integrated directly into the system of the website provider. In one or more embodiments, the virtual showcase method of display may enhance and ensure the authenticity of the virtual memorabilia.

### Methods of Authentication

A digital signature or digital signature scheme, not to be confused with a digital autograph as used herein, are well known in the computer arts. Digital signatures may be a type of asymmetric cryptography used to simulate the security properties of a handwritten signature on paper. Digital signature schemes normally give two algorithms, one for “signing” a data object, which involves the applying the source user's secret or private key, and one for verifying or authenticating the signature, which involves applying the user's public key. The output of the signature process is called the “digital signature.”

A digital signature may be used to authentication of a data object. Digital signatures are used to create public key infrastructure (PKI) schemes in which a user's public key (whether for public-key encryption, digital signatures, or any other purpose) is tied to a user by a digital identity certificate issued by a certificate authority. PKI schemes attempt to unbreakably bind user information (name, address, phone number, etc.) to a public key, so that public keys can be used as a form of identification. Public key encryption schemes are well known in the computer arts and will not be discussed further herein.

Digital signatures may be used to implement electronic signatures, a broader term that generally refers to any electronic data that carries the intent of a signature, but not all electronic signatures use digital signatures.

Although data may often include information about the entity sending a message, that information may not be accurate. Digital signatures can be used to authenticate the source of messages. When ownership of a digital signature secret key is bound to a specific user, a valid signature shows that the message was sent by that user. The importance of high confidence in sender authenticity is especially obvious in context of the present invention. Memorabilia is only valuable when it is in limited supply. However, computers, by their nature, make it very simple to make copies of digital data. Thus, limited edition digital data would appear to be an oxymoron. The system and method of the present invention overcomes this challenge by using the above described authentication method, or other methods well known to those of ordinary skill in the cryptograph arts, to verify that a digital image and/or digital autograph are authentic and not an illegal copy.

In many scenarios in the system of the present invention, the buyer and seller of authentic digital memorabilia may have a need for confidence that the memorabilia has not been copied or altered during transmission. This need is integral to the concept of the present invention providing a marketplace where digital memorabilia obtains and retains value. Digital signatures are a preferred method of authentication for the system of the present invention, because while encryption hides the contents of a message, it may be possible to change an encrypted message without understanding it. However, if an object is digitally signed, any change in the object will invalidate the signature. Furthermore, there is no efficient way to modify an object and its signature to produce a new object with a valid signature, because this is still considered to be computationally infeasible by most cryptographic hash functions. Thus, the use of digital signatures is a preferred method of authentication for the digital objects of the present invention.

Other technologies for authenticating virtual memorabilia contemplated by the present invention may include digital visible and invisible watermarking technologies, or other types of keys that may be stored in a database to prove authenticity and present ownership of each virtual memorabilia item.

### Computer System

The system of the present invention may be implemented on one or more computers and software that may provide a web-based user interface. Such an interface is preferred because it is easily accessible to most potential users of the system, providing support for many platforms and operating systems. A computer system capable of supporting the present invention may include a desktop or laptop PC, including various well known input and output devices, as well as an Internet connection using one of any number of well known options such as dial-up, DSL, satellite and others. The data repository for data objects of the present invention may be hosted on one or more servers connected by network means to the Internet or other type of computer network. Various devices may be used to monitor and participate in the marketplace of the present invention, including Wireless Access Protocol (WAP) cellular telephones, Internet capable Personal Data Assistants (PDAs), laptops, home computers, computers which can access the Internet via satellite from an automobile or other mobile vehicle, or any other wired or wireless means of accessing the Internet, World Wide Web (WWW), or network of the invention. Such devices allow users to participate in real time auctions and sales of authentic virtual memorabilia using the system and method of the present invention. Digital images and digital autographs in the system of the present invention may be captured by various devices well known to those of ordinary skill in the art, including digital cameras, scanners, digital pens and other such devices. Digital images and digital autographs may also be created using animation software or other computer program. Web-based computer software is preferred for presenting the marketplace of the present invention because it is easily changed to adjust for changes to the system as it is upgraded or features are changed. Web-based software may provide identical or similar user interfaces across multiple platforms, reducing user interface training for users and others who may input or examine memorabilia in the system.

The present invention will create a marketplace where authentic virtual memorabilia can be purchased, sold, traded or displayed as part of a showcase, as part of the growing virtual economy. While the invention herein disclosed has been described by means of specific embodiments and applications thereof, numerous modifications and variations could be made thereto by those skilled in the art without departing from the scope of the invention set forth in the claims.

What is claimed is:

1. A system for creating and marketing authentic virtual memorabilia comprising:
at least one computer server;
at least one database connected to said at least one computer server;
a communication connection for connecting said at least one computer server to a network;
software hosted on said at least one computer server, said software configured to create a marketplace for limited edition authentic virtual memorabilia;
said software further configured to provide an auction environment for said authentic virtual memorabilia;
said software further configured to allow display of said limited edition authentic virtual memorabilia in a showcase.
